(19) United States
(12) Patent Application Publication
(10) Pub. No.: US 2026/0368856 A1
(43) Pub. Date: Nov. 19, 2026

(54) VIDEO COMPLETION METHOD AND APPARATUS, MEDIUM AND ELECTRONIC DEVICE

(71) Applicant: Beijing Zitiao Network Technology Co., Ltd., Beijing (CN)

(72) Inventors: Qiang ZHOU, Beijing (CN); Shiyin WANG, Beijing (CN); Hang ZHAO, Beijing (CN); Junjie SU, Beijing (CN)

(21) Appl. No.: 19/148,295

(22) PCT Filed: Dec. 11, 2023
(86) PCT No.: PCT/CN2023/137808

§ 371 Date: Jul. 15, 2025

(30) Foreign Application Priority Data
Jan. 16, 2023 (CN) 202310076871.0

(51) Int. Cl. G06T 5/50; G06T 3/60; G06T 5/20; G06T 5/70; G06T 7/194

(52) U.S. Cl. CPC G06T 5/50; G06T 3/60; G06T 5/20; G06T 5/70; G06T 7/194; G06T 2207/10016; G06T 2207/20032

(57) ABSTRACT

The present disclosure relates to a video supplementation method and apparatus, a medium and an electronic device. The video supplementation method includes: acquiring a first background feature point from a first to-be-supplemented frame of a to-be-supplemented video, and acquiring a second background feature point from a previous frame of the first to-be-supplemented frame, wherein the first background feature point is a feature point extracted from the background of the first to-be-supplemented frame, and the second background feature point is a feature point extracted from the background of the previous frame; and converting a supplementary frame of the previous frame by using the first and the second background feature point to obtain a conversion frame, wherein the supplementary frame of the previous frame is a frame obtained by video supplementation; and performing video supplementation on the first to-be-supplemented frame by using the conversion frame to obtain a target video.

### CROSS-REFERENCE TO RELATED APPLICATIONS

The present application claims the priority to the Chinese patent application No. 202310076871.0 entitled “VIDEO COMPLETION METHOD AND APPARATUS, MEDIUM AND ELECTRONIC DEVICE” and filed on Jan. 16, 2023, the disclosure of which is incorporated by reference herein in its entirety.

### TECHNICAL FIELD

The present disclosure relates to the technical field of image processing, and specifically to a video completion method and apparatus, a medium and an electronic device.

### BACKGROUND

In the related art, video completion is generally performed by using a depth model, but the completion result of the method is generally fuzzy and real time performance cannot be guaranteed.

### SUMMARY

The “SUMMARY” is provided to introduce concepts in a simplified form, which will be described in detail below in the following “DETAILED DESCRIPTION”. The “SUMMARY” is not intended to identify key features or essential features of the claimed technical solutions, nor is it intended to limit the scope of the claimed technical solutions.

In a first aspect, the present disclosure provides a video completion method, comprising: acquiring first background feature points from a first to-be-completed frame of a to-be-completed video and acquiring second background feature points from a previous frame of the first to-be-completed frame, wherein the first background feature points are feature points extracted from a background of the first to-be-completed frame, and the second background feature points are feature points extracted from a background of the previous frame; transforming a completion frame of the previous frame by using the first background feature points and the second background feature points to obtain a transformation frame, wherein the completion frame of the previous frame is a frame obtained by video completion; and performing the video completion on the first to-be-completed frame by using the transformation frame to obtain a target video.

In a second aspect, the present disclosure provides a video completion apparatus, comprising: an acquisition module configured to acquire first background feature points from a first to-be-completed frame of a to-be-completed video and acquire second background feature points from a previous frame of the first to-be-completed frame, wherein the first background feature points are feature points extracted from a background of the first to-be-completed frame, and the second background feature points are feature points extracted from a background of the previous frame; a transformation module configured to transform a completion frame of the previous frame by using the first background feature points and the second background feature points to obtain a transformation frame, wherein the completion frame of the previous frame is a frame obtained by video completion; and a completion module configured to perform the video completion on the first to-be-completed frame by using the transformation frame to obtain a target video.

In a third aspect, the present disclosure provides a non-transitory computer-readable medium having thereon stored a computer program which, when executed by a processing device, implements the method according to any item in the first aspect of the present disclosure.

In a fourth aspect, the present disclosure provides an electronic device, comprising: a storage device having a computer program stored thereon; and a processing device configured to execute the computer program in the storage device, to implement the method according to any item in the first aspect of the present disclosure.

In a fifth aspect, the present disclosure provides a computer program product comprising instructions which, when executed by a processor, implement the method according to any item in the first aspect of the present disclosure.

In a sixth aspect, the present disclosure provides a computer program which, when executed by a processor, implements the method according to any item in the first aspect of the present disclosure.

Other features and advantages of the present disclosure will be described in detail in the following “DETAILED DESCRIPTION”.

### BRIEF DESCRIPTION OF THE DRAWINGS

The above and other features, advantages, and aspects of the embodiments of the present disclosure will become more apparent by combining the accompanying drawings and referring to the following “DETAILED DESCRIPTION”. Throughout the drawings, the same or similar reference numbers refer to the same or similar elements. It should be understood that the drawings are schematic and that components and elements are not necessarily drawn to scale. In the drawings:

FIG. 1 is a flow diagram of a video completion method according to an embodiment of the present disclosure.

FIG. 2 illustrates a schematic diagram of a frame before segmentation according to an embodiment of the present disclosure.

FIG. 3 illustrates a schematic diagram after frame segmentation according to an embodiment of the present disclosure.

FIG. 4 is another flow diagram of a video completion method according to an embodiment of the present disclosure.

FIG. 5 is a flow diagram of the video completion when an inertial measurement unit is available according to an embodiment of the present disclosure.

FIG. 6 is a flow diagram of the video completion when an inertial measurement unit is unavailable according to an embodiment of the present disclosure.

FIG. 7 is a schematic block diagram of a video completion apparatus according to an embodiment of the present disclosure.

FIG. 8 illustrates a schematic structural diagram of an electronic device suitable for implementing an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be implemented in various forms and should not be construed as limited to the embodiments set forth herein, rather these embodiments are provided for a more complete and thorough understanding of the present disclosure. It should be understood that the drawings and the embodiments of the present disclosure are for exemplary purposes only and are not intended to limit the scope of protection of the present disclosure.

It should be understood that steps recited in method implementations of the present disclosure may be performed in a different order, and/or performed in parallel. Furthermore, the method implementations may include additional steps and/or omit performing the illustrated steps. The scope of the present disclosure is not limited in this respect.

The “including” and variations thereof used herein are intended to be open-ended, i.e., “including but not limited to”. The term “based on” is “at least partially based on”. The term “one embodiment” means “at least one embodiment”; the term “another embodiment” means “at least one other embodiment”; and the term “some embodiments” means “at least some embodiments”. Definitions related to other terms will be given in the following description.

It should be noted that the concepts “first”, “second”, and the like mentioned in the present disclosure are only used for distinguishing different devices, modules or units, and are not used for limiting the order or interdependence of functions performed by the devices, modules or units.

It should be noted that the modification of “a” or “a plurality” mentioned in the present disclosure is intended to be illustrative rather than restrictive, and that those skilled in the art should appreciate that it should be understood as “one or more” unless otherwise explicitly stated in the context.

Names of messages or information exchanged between a plurality of devices in the implementations of the present disclosure are for illustrative purposes only, and are not intended to limit the scope of the messages or information.

It can be understood that, before the technical solutions disclosed in the embodiments of the present disclosure are used, a user should be notified of a type, a usage scope, a usage scenario, etc. of personal information involved in the present disclosure in a proper manner according to related laws and regulations, and authorization from the user is obtained.

For example, in response to receiving an active request of the user, prompt information is sent to the user to explicitly prompt the user that an operation he requests to be performed would require acquisition and use of the personal information of the user. Thus, this enables the user to, according to the prompt information, autonomously select whether to provide the personal information to software or hardware such as an electronic device, an application, a server, or a storage medium, which performs operations of the technical solutions of the present disclosure.

As an optional but non-limiting implementation, in response to receiving an active request of the user, the manner of sending the prompt information to the user may be, for example, in a manner of a pop-up window, where the prompt information may be presented in a manner of text. In addition, in the pop-up window, a selection control provided for the user to select “agree” or “disagree” on providing the personal information to the electronic device can be carried.

It can be understood that the above processes of notification and acquisition of the authorization from the user are only illustrative and not intended to limit the implementation of the present disclosure, and other manners in line with the related laws and regulations may also be applied to the implementation of the present disclosure.

Meanwhile, it can be understood that data involved in this technical solution (including but not limited to the data itself, acquisition or use of the data) should comply with the requirements of the related laws and regulations and related provisions.

With the technical solution of the present disclosure, it is possible to first acquire first background feature points from a first to-be-completed frame of a to-be-completed video and acquire second background feature points from a previous frame of the first to-be-completed frame, then transform a completion frame of the previous frame by using the first background feature points and the second background feature points to obtain a transformation frame, and perform the video completion on the first to-be-completed frame by using the transformation frame, so that background information in the frame can be fully utilized, translation and rotation information of the first to-be-completed frame relative to its previous frame can be accurately estimated, improving the accuracy of the video completion, and improving the definition of the video completion result. Moreover, compared with a video completion solution solely based on the feature points in the related art, the present disclosure can greatly reduce computation amount and settle the issues of mis-projection and low accuracy. In addition, due to great reduction in the computation amount, the present disclosure can perform the video completion in real time.

FIG. 1 is a flow diagram of a video completion method according to an embodiment of the present disclosure. As shown in FIG. 1, the video completion method comprises the following steps S11 to S13.

In step S11, first background feature points are acquired from a first to-be-completed frame of a to-be-completed video, and second background feature points are acquired from a previous frame of the first to-be-completed frame, wherein the first background feature points are feature points extracted from a background of the first to-be-completed frame, and the second background feature points are feature points extracted from a background of the previous frame.

The to-be-completed video refers to a video on which completion needs to be performed.

The first to-be-completed frame refers to a frame on which video completion is currently about to be performed. The first to-be-completed frame may or may not be a frame captured at a current moment. For example, if the current moment is 12:10, the first to-be-completed frame may be a frame which is captured at 12:10 and on which the video completion is currently performed, or a frame which has been captured at 12:09 and on which the video completion is currently performed.

The feature point refers to a point with a drastic change in a gray value or a point with a large curvature on an edge of an image (i.e., an intersection of two edges). The feature point can be used to identify a target object in the image. For example, the feature point may be a corner, a vertex, an inflection point, and the like.

In some embodiments, the first background feature points and the second background feature points may be acquired in the following manner.

First, a foreground area and a background area of the first to-be-completed frame and the previous frame of the first to-be-completed frame are segmented respectively, to obtain a first background and a second background respectively.

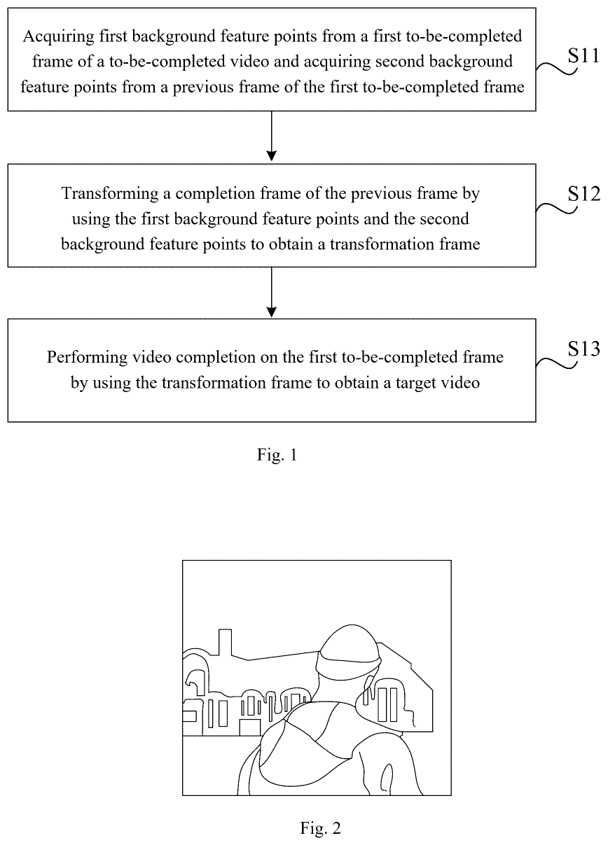

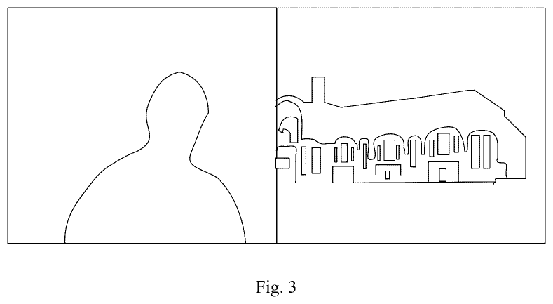

For example, by using an image segmentation algorithm (e.g., a human figure segmentation algorithm or another type of segmentation algorithm capable of distinguishing a background area and a foreground area), it is possible to segment the foreground area and the background area of the first to-be-completed frame to obtain the first background, and segment the foreground area and the background area of the previous frame of the first to-be-completed frame to obtain the second background. The foreground area refers to an area in a lens close to a front human or object, for example, a human figure, an object, an animal, or the like. The background area refers to an area other than the foreground area. FIG. 2 illustrates a schematic diagram of a frame before segmentation according to an embodiment of the present disclosure, and FIG. 3 illustrates a schematic diagram after frame segmentation according to an embodiment of the present disclosure, with a foreground area on the left and a background area on the right in FIG. 3.

Then, the first background feature points are extracted from the first background, and the second background feature points are extracted from the second background. In this way, the first background feature points and the second background feature points can be acquired, respectively.

In step S12, a completion frame of the previous frame of the first to-be-completed frame is transformed by using the first background feature points and the second background feature points to obtain a transformation frame, wherein the completion frame of the previous frame is obtained by video completion.

That is, before video completion is performed on the first to-be-completed frame, the video completion has been performed on the previous frame of the first to-be-completed frame, so that the video completion can be performed on the first to-be-completed frame by using the completion frame of the previous frame.

In step S13, the video completion is performed on the first to-be-completed frame by using the transformation frame to obtain a target video.

In some embodiments, the video completion may be performed on the first to-be-completed frame by replacing the foreground area of the first to-be-completed frame with an area in the transformation frame that corresponds to the foreground area of the first to-be-completed frame. That is, the area corresponding to the foreground area of the first to-be-completed frame is found in the transformation frame, and then the foreground area of the first to-be-completed frame is replaced with the corresponding area, so that the background area of the first to-be-completed frame that corresponds to the foreground area can be completed to finish the video completion of the first to-be-completed frame.

With the above technical solution, it is possible to first acquire first background feature points from a first to-be-completed frame of a to-be-completed video and acquire second background feature points from a previous frame of the first to-be-completed frame, then transform a completion frame of the previous frame by using the first background feature points and the second background feature points to obtain a transformation frame, and perform video completion on the first to-be-completed frame by using the transformation frame, so that background information in the frame can be fully utilized, translation and rotation information of the first to-be-completed frame relative to its previous frame can be accurately estimated, improving the accuracy of the video completion, and improving the definition of the video completion result. Moreover, compared with a video completion solution solely based on the feature points in the related art, the present disclosure can greatly reduce the computation amount and settle the issues of mis-projection and low accuracy. In addition, due to great reduction in the computation amount, the present disclosure can perform the video completion in real time.

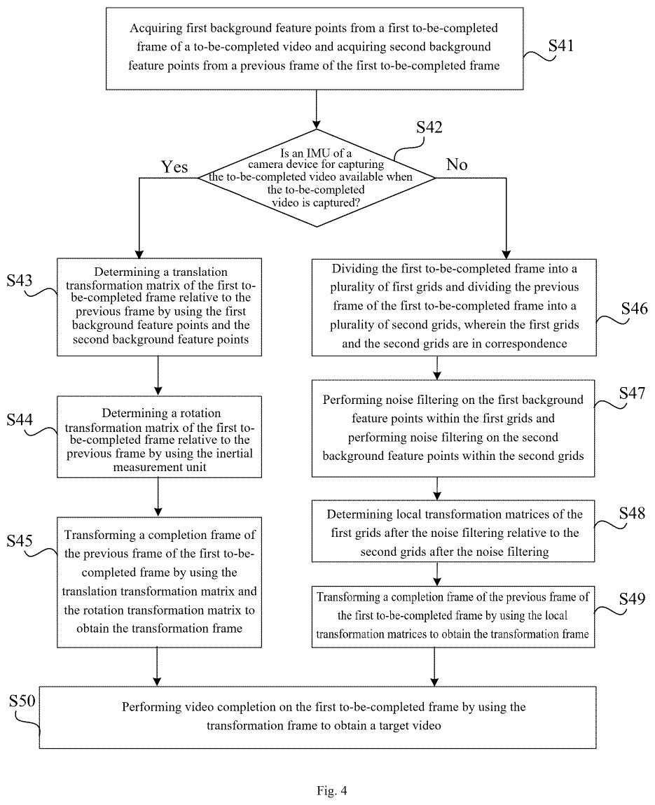

FIG. 4 is another flow diagram of a video completion method according to an embodiment of the present disclosure.

As shown in FIG. 4, first, in step S41, first background feature points are acquired from a first to-be-completed frame of a to-be-completed video, and second background feature points are acquired from a previous frame of the first to-be-completed frame.

The manner of acquiring the first background feature points and the second background feature points has already been described in detail above, and is not repeated herein.

Then, in step S42, it is determined whether an inertial measurement unit (IMU) of a camera device for capturing the to-be-completed video is available when the to-be-completed video is captured. If the IMU is available when the to-be-completed video is captured, it goes to step S43, and if the IMU is unavailable when the to-be-completed video is captured, it goes to step S46.

In step S43, if the IMU is available when the to-be-completed video is captured, a translation transformation matrix of the first to-be-completed frame relative to the previous frame is determined by using the first background feature points and the second background feature points. Theoretically, without rotation, the previous frame of the first to-be-completed frame may be transformed into the first to-be-completed frame by using the translation transformation matrix.

In step S44, if the IMU is available when the to-be-completed video is captured, a rotation transformation matrix of the first to-be-completed frame relative to the previous frame is determined by using the inertial measurement unit. Theoretically, without translation, the previous frame of the first to-be-completed frame can be transformed into the first to-be-completed frame by using the rotation transformation matrix.

It should be noted that, in the present disclosure, the execution order of the step of determining the translation transformation matrix and the step of determining the rotation transformation matrix is not limited, for example, the two steps may be executed simultaneously or in a sequential order, for example, the translation transformation matrix is determined first and then the rotation transformation matrix is determined, or the rotation transformation matrix is determined first and then the translation transformation matrix is determined.

In step S45, a completion frame of the previous frame of the first to-be-completed frame is transformed by using the translation transformation matrix and the rotation transformation matrix to obtain a transformation frame.

For example, it is possible to multiply the translation transformation matrix and the rotation transformation matrix, and then transform the completion frame of the previous frame of the first to-be-completed frame by using the multiplied transformation matrix, that is, by multiplying the completion frame of the previous frame of the first to-be-completed frame by the multiplied transformation matrix, the completion frame of the previous frame of the first to-be-completed frame can be transformed.

For another example, it is possible to first perform translation transformation on the completion frame of the previous frame of the first to-be-completed frame by using the translation transformation matrix, and then perform rotation transformation on the frame after the translation transformation by using the rotation transformation matrix.

For another example, it is possible to first perform rotation transformation on the completion frame of the previous frame of the first to-be-completed frame by using the rotation transformation matrix, and then perform translation transformation on the frame after the rotation transformation by using the translation transformation matrix.

The transformation implemented by using the translation transformation matrix and the rotation transformation matrix is a perspective transformation, i.e. a WarpPerspective transformation.

By the transformation of the steps S43 to S45, since the inertial measurement unit can provide an accurate rotation pose related to the camera device, the accuracy of the transformation of the completion frame of the previous frame of the first to-be-completed frame can be improved, and the improved transformation accuracy means that the accuracy of video completion is also improved.

In step S46, if the inertial measurement unit is unavailable when the to-be-completed video is captured, the first to-be-completed frame is divided into a plurality of first grids, and the previous frame of the first to-be-completed frame is divided into a plurality of second grids, wherein the first grids and the second grids are in correspondence.

Any grid division method can be adopted to perform grid division on the first to-be-completed frame and the previous frame of the first to-be-completed frame. For example, a grid division method may be: average division into N parts in a horizontal direction and average division into M parts in a vertical direction; another grid division method may be: grid division according to gray values of an image; yet another grid division method may be: grid division according to chrominance values in an image; and so on.

In some embodiments, completely the same grid division method may be adopted for the first to-be-completed frame and the previous frame of the first to-be-completed frame, so that the first grids and the second grids are in correspondence. That is, after the grid division is finished, the grids presented by the first to-be-completed frame are completely identical with the grids presented by the previous frame of the first to-be-completed frame. With such configuration, the transformation accuracy in the subsequent transformation can be ensured.

In step S47, noise filtering is performed on the first background feature points within the first grids, and the noise filtering is performed on the second background feature points within the second grids.

In some embodiments, the noise filtering on the first background feature points within the first grids and the noise filtering on the second background feature points within the second grids may be performed by performing median filtering with a preset radius. For example, the noise filtering may be performed by taking a median of background feature points within the preset radius. A size of the preset radius can be set according to effect requirements for the noise filtering. For example, the preset radius may be set small, so that there are a plurality of areas covered by the preset radius within each of the first grid and the second grid; alternatively, the preset radius may be set large, so that there is only one area covered by the preset radius in each of the first grid and the second grid. By the noise filtering, noise points within the first grid and the second grid can be effectively eliminated.

In step S48, local transformation matrices of the first grids after the noise filtering relative to the second grids after the noise-filtering are determined, wherein the local transformation matrix is a homography matrix.

After the noise filtering, a local transformation matrix of each first grid relative to a corresponding second grid can be determined according to the first background feature points within the first grids after the noise-filtering and the second background feature points within the second grids after the noise-filtering.

For example, the first to-be-completed frame is divided into 3 first grids, i.e., a first grid 1, a first grid 2 and a first grid 3, respectively; the previous frame of the first to-be-completed frame is also divided into 3 grids, i.e., a second grid 1, a second grid 2 and a second grid 3, respectively, wherein the first grid 1 and the second grid 1 are in correspondence, the first grid 2 and the second grid 2 are in correspondence, the first grid 3 and to the second grid 3 are in correspondence; and a local transformation matrix between the first grid 1 and the second grid 1 is a local transformation matrix 1, a local transformation matrix between the first grid 2 and the second grid 2 is a local transformation matrix 2, and a local transformation matrix between the first grid 3 and the second grid 3 is a local transformation matrix 3. In this way, the local transformation matrix between each first grid and the corresponding second grid is determined.

In step S49, a completion frame of the previous frame of the first to-be-completed frame is transformed by using the local transformation matrices to obtain a transformation frame.

In some embodiments, an area in the completion frame of the previous frame of the first to-be-completed frame that corresponds to each second grid may be transformed by using each corresponding local transformation matrix, for example, the area in the completion frame of the previous frame of the first to-be-completed frame that corresponds to the second grid is multiplied by a corresponding local transformation matrix, so that the completion frame of the previous frame of the first to-be-completed frame can be transformed. That is, the completion frame of the previous frame of the first to-be-completed frame is transformed grid by grid in units of grids.

By still taking the above example as an example, an area in the completion frame of the previous frame of the first to-be-completed frame that corresponds to the second grid 1 is transformed by using the local transformation matrix 1, an area in the completion frame of the previous frame of the first to-be-completed frame that corresponds to the second grid 2 is transformed by using the local transformation matrix 2, and an area in the completion frame of the previous frame of the first to-be-completed frame that corresponds to the second grid 3 is transformed by using the local transformation matrix 3, so that the whole completion frame of the previous frame of the first to-be-completed frame is transformed grid by grid.

In addition, since there may be some errors in the transformation result by the local transformation matrices, in some embodiments, the step S49 may also be implemented in the following manner. First, the completion frame of the previous frame of the first to-be-completed frame is transformed by using the local transformation matrices to obtain a to-be-compensated frame. Then, the to-be-compensated frame is compensated by using an optical flow to obtain the transformation frame. For example, the compensation may be performed by using DenseFlow, ScalarOffset, or the like. That is, when there is a certain error in the transformation performed by using the local transformation matrices, since a point on the first to-be-completed frame that corresponds to a pixel point on the previous frame of the first to-be-completed frame can be found out according to the optical flow, the above error can be compensated by using the optical flow, so that the finally obtained transformation frame is more accurate.

By the transformation of the steps S46 to S49, the first to-be-completed frame and its previous frame are first grid-divided, and the noise filtering is performed grid by grid to filter out noise points in the background feature points, then the local transformation matrices of the first grids of the first to-be-completed frame relative to the second grids of the previous frame of the first to-be-completed frame are determined according to the filtered grids, then the completion frame of the previous frame of the first to-be-completed frame is transformed grid by grid by using the local transformation matrices, therefore, the transformation accuracy is improved by the noise filtering and the transformation grid by grid.

Then, in step S50, video completion is performed on the first to-be-completed frame by using the transformation frame to obtain a target video. How to perform the video completion has already been described in detail above, and is not repeated herein.

With the above technical solution, it is possible to first acquire first background feature points from a first to-be-completed frame of a to-be-completed video and acquire second background feature points from a previous frame of the first to-be-completed frame, then transform a completion frame of the previous frame by using the first background feature points and the second background feature points to obtain a transformation frame, and perform video completion on the first to-be-completed frame by using the transformation frame, so that background information in the frame can be fully utilized, translation and rotation information of the first to-be-completed frame relative to its previous frame can be accurately estimated, improving the accuracy of the video completion, and improving the definition of the video completion result. Moreover, compared with a video completion solution solely based on the feature points in the related art, the present disclosure can greatly reduce the computation amount and settle the issues of mis-projection and low accuracy. In addition, due to great reduction in the computation amount, the present disclosure can perform video completion in real time.

In some embodiments, the video completion method according to the embodiment of the present disclosure may further comprise: if the first to-be-completed frame is a first frame of the to-be-completed video, performing the video completion on the first to-be-completed frame by using a depth completion network. That is, if the first to-be-completed frame is the first frame of the to-be-completed video, the previous frame of the first to-be-completed frame does not exist, and therefore, it is impossible to determine the transformation of the first to-be-completed frame relative to its previous frame by using the background feature points in the first to-be-completed frame and its previous frame as described above, so that, in this case, the video completion can be performed on the first to-be-completed frame by using the depth completion network.

In some embodiments, an edge area of the first to-be-completed frame may be completed by using a traditional video completion algorithm. In this way, by performing the video completion by using the traditional video completion algorithm in the edge area of the first to-be-completed frame and performing the video completion by using the method described above with reference to FIGS. 1 and 4 in the foreground area of the first to-be-completed frame, the video completion of the whole first to-be-completed frame can be finished.

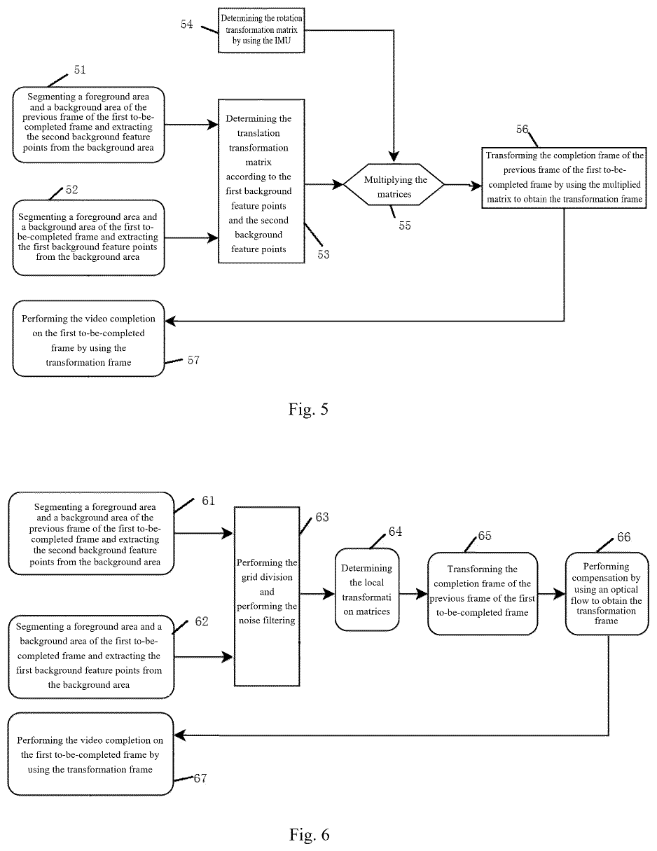

FIG. 5 is a flow diagram of the video completion when an inertial measurement unit is available according to an embodiment of the present disclosure.

As shown in FIG. 5, first, in step S51, a foreground area and a background area of the previous frame of the first to-be-completed frame are segmented and the second background feature points are extracted from the background area, and in step S52, a foreground area and a background area of the first to-be-completed frame are segmented and the first background feature points are extracted from the background area. The execution order of the steps S51 and S52 is not limited, and they may be executed simultaneously or in a sequential order.

Then, in step S53, a translation transformation matrix Ht is determined according to the first background feature points and the second background feature points, and in step S54, a rotation transformation matrix Hr is determined by using the inertial measurement unit. The frame segmentation, the extraction of the background feature points, the determination of the translation transformation matrix and the rotation transformation matrix, etc. have already been described in detail above, and are not repeated herein.

In addition, the execution order of the step S54 with respect to the steps S51 to S53 is not limited. For example, the step S54 may be performed simultaneously or sequentially with any of the steps S51 to S53.

Then, in step S55, the translation transformation matrix Ht and the rotation transformation matrix Hr are multiplied.

Then, in step S56, the completion frame of the previous frame of the first to-be-completed frame is transformed by using the multiplied matrix to obtain a transformation frame. The specific transformation process has already been described in detail above, and is not repeated herein.

Then, in step S57, the video completion is performed on the first to-be-completed frame by using the transformation frame. The specific video completion process has already been described in detail above, and is not be repeated herein.

With the above technical solution, it is possible to fully utilize the background information in the frame and the characteristic of the inertial measurement unit that can accurately measure the rotation pose, so that the translation and rotation information of the first to-be-completed frame relative to its previous frame can be accurately estimated, improving the accuracy of the video completion, and improving the definition of the video completion result. Moreover, compared with a video completion solution solely based on the feature points in the related art, the present disclosure can greatly reduce the computation amount and settle the issues of mis-projection and low accuracy. In addition, due to great reduction in the computation amount, the present disclosure can perform the video completion in real time.

FIG. 6 is a flow diagram of the video completion when an inertial measurement unit is unavailable according to an embodiment of the present disclosure.

As shown in FIG. 6, first, in step S61, a foreground area and a background area of the previous frame of the first to-be-completed frame are segmented and the second background feature points are extracted from the background area, and in step S62, a foreground area and a background area of the first to-be-completed frame are segmented and the first background feature points are extracted from the background area. The frame segmentation, the extraction of the background feature points, and the like, have already been described in detail above, and are not repeated herein.

Then, in step S63, the grid division and the noise filtering are performed on the first to-be-completed frame and its previous frame. The specific grid division and noise filtering processes have been described in detail above, and are not repeated herein.

Then, in step S64, the local transformation matrices are determined by using the grids after the noise filtering. The specific determination process of the local transformation matrices has already been described in detail above, and is not repeated herein.

Then, in step S65, the completion frame of the previous frame of the first to-be-completed frame is transformed by using the local transformation matrices. The specific transformation process has already been described in detail above, and is not repeated herein.

Then, in step S66, the transformation result in the step S65 is compensated by using an optical flow to obtain the transformation frame.

Then, in step S67, the video completion is performed on the first to-be-completed frame by using the transformation frame. The specific video completion process has already been described in detail above and is not be repeated herein.

With the above technical solution, it is possible to fully utilize the background information in the frame and the completion frame obtained by transformation grid by grid for the video completion, so that the translation and rotation information of the first to-be-completed frame relative to its previous frame can be accurately estimated, improving the accuracy of the video completion, and improving the definition of the video completion result. Moreover, compared with a video completion solution solely based on the feature points in the related art, the present disclosure can greatly reduce the computation amount and settle the issues of mis-projection and low accuracy. In addition, due to great reduction in the computation amount, the present disclosure can perform the video completion in real time.

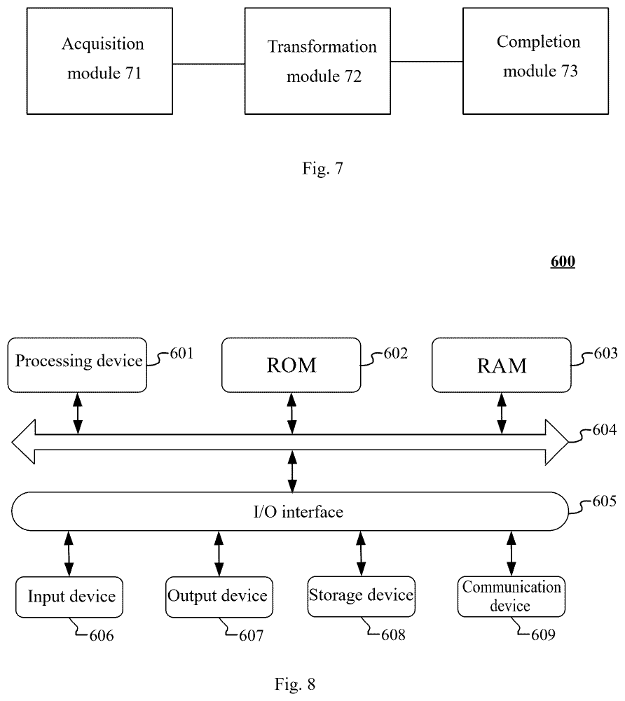

FIG. 7 is a schematic block diagram of a video completion apparatus according to an embodiment of the present disclosure. As shown in FIG. 7, the video completion apparatus comprises: an acquisition module 71 configured to acquire first background feature points from a first to-be-completed frame of a to-be-completed video and acquire second background feature points from a previous frame of the first to-be-completed frame, wherein the first background feature points are feature points extracted from a background of the first to-be-completed frame, and the second background feature points are feature points extracted from a background of the previous frame; a transformation module 72 configured to transform a completion frame of the previous frame by using the first background feature points and the second background feature points to obtain a transformation frame, wherein the completion frame of the previous frame is a frame obtained by video completion; and a completion module 73 configured to perform the video completion on the first to-be-completed frame by using the transformation frame to obtain a target video.

With the above technical solution, it is possible to first acquire first background feature points from a first to-be-completed frame of a to-be-completed video and acquire second background feature points from a previous frame of the first to-be-completed frame, then transform a completion frame of the previous frame by using the first background feature points and the second background feature points to obtain a transformation frame, and perform the video completion on the first to-be-completed frame by using the transformation frame, so that background information in the frame can be fully utilized, translation and rotation information of the first to-be-completed frame relative to its previous frame can be accurately estimated, improving the accuracy of the video completion, and improving the definition of the video completion result. Moreover, compared with a video completion solution solely based on the feature points in the related art, the present disclosure can greatly reduce the computation amount and settle the issues of mis-projection and low accuracy. In addition, due to great reduction in the computation amount, the present disclosure can perform the video completion in real time.

Optionally, the acquiring first background feature points from a first to-be-completed frame of a to-be-completed video, and acquiring second background feature points from a previous frame of the first to-be-completed frame, by the acquisition module 71, comprises: segmenting a foreground area and a background area of the first to-be-completed frame and the previous frame respectively to obtain a first background and a second background respectively; and extracting the first background feature points from the first background and extracting the second background feature points from the second background.

Optionally, the transforming a completion frame of the previous frame by using the first background feature points and the second background feature points to obtain a transformation frame, by the transformation module 72, comprises: determining whether an inertial measurement unit of a camera device for capturing the to-be-completed video is available when the to-be-completed video is captured; and transforming the completion frame of the previous frame, on the basis of a determination result, the first background feature points, and the second background feature points, to obtain the transformation frame.

Optionally, the transforming the completion frame of the previous frame, on the basis of a determination result, the first background feature points, and the second background feature points, to obtain the transformation frame, by the transformation module 72, comprises: if the determination result indicates that the inertial measurement unit is available when the to-be-completed video is captured, determining a translation transformation matrix of the first to-be-completed frame relative to the previous frame by using the first background feature points and the second background feature points; determining a rotation transformation matrix of the first to-be-completed frame relative to the previous frame by using the inertial measurement unit; and transforming the completion frame of the previous frame by using the translation transformation matrix and the rotation transformation matrix.

Optionally, the transforming the completion frame of the previous frame, on the basis of a determination result, the first background feature points, and the second background feature points, to obtain the transformation frame, by the transformation module 72, comprises: if the inertial measurement unit is unavailable when the to-be-completed video is captured, dividing the first to-be-completed frame into a plurality of first grids and dividing the previous frame into a plurality of second grids, wherein the first grids and the second grids are in correspondence; performing noise filtering on the first background feature points within the first grids and performing the noise filtering on the second background feature points within the second grids; determining local transformation matrices of the first grids after the noise filtering relative to the second grids after the noise filtering, wherein the local transformation matrix is a homography matrix; and transforming the completion frame of the previous frame by using the local transformation matrices to obtain the transformation frame.

Optionally, the performing noise filtering on the first background feature points within the first grids and performing the noise filtering on the second background feature points within the second grids, by the transformation module 72, comprises: performing the noise filtering on the first background feature points within the first grids and performing the noise filtering on the second background feature points within the second grids by performing median filtering with a preset radius.

Optionally, the transforming the completion frame of the previous frame by using the local transformation matrices to obtain the transformation frame, by the transformation module 72, comprises: transforming the completion frame of the previous frame by using the local transformation matrices to obtain a to-be-compensated frame; and compensating the to-be-compensated frame by using an optical flow to obtain the transformation frame.

Optionally, the performing the video completion on the first to-be-completed frame by using the transformation frame, by the completion module 73, comprises: performing the video completion on the first to-be-completed frame by replacing a foreground area of the first to-be-completed frame with an area in the transformation frame that corresponds to the foreground area of the first to-be-completed frame.

Optionally, the completion module 73 is further configured to: performing the video completion on the first to-be-completed frame by using a deep completion network if the first to-be-completed frame is a first frame of the to-be-completed video.

Refer to FIG. 8 below, which illustrates a schematic structural diagram of an electronic device 600 suitable for implementing an embodiment of the present disclosure. The terminal device in the embodiment of the present disclosure may include, but is not limited to, a mobile terminal such as a mobile phone, a laptop, a digital broadcast receiver, a PDA (Personal Digital Assistant), a PAD (tablet), a PMP (Portable Multimedia Player), a vehicle-mounted terminal (e.g., a vehicle-mounted navigation terminal), and the like, and a fixed terminal such as a digital TV, a desktop, and the like. The electronic device shown in FIG. 8 is only an example, and should not bring any limitation to the functions and the scope of use of the embodiment of the present disclosure.

As shown in FIG. 8, the electronic device 600 may comprise a processing device (e.g., a central processor, graphics processor, etc.) 601 that may perform various appropriate actions and processes according to a program stored in a read-only memory (ROM) 602 or a program loaded from a storage device 608 into a random access memory (RAM) 603. In the RAM 603, various programs and data required for the operation of the electronic device 600 are also stored. The processing device 601, the ROM 602, and the RAM 603 are connected to each other via a bus 604. An input/output (I/O) interface 605 is also connected to the bus 604.

Generally, the following devices may be connected to the I/O interface 605: an input device 606 including, for example, a touch screen, touch pad, keyboard, mouse, camera, microphone, accelerometer, gyroscope, etc.; an output device 607 including, for example, a liquid crystal display (LCD), speaker, vibrator, etc.; the storage device 608 including, for example, a magnetic tape, hard disk, etc.; and a communication device 609. The communication device 609 may allow the electronic device 600 to communicate with other devices wirelessly or by wire to exchange data. While FIG. 8 illustrates the electronic device 600 having various devices, it should be understood that there is no requirement that all the illustrated devices are implemented or provided. More or fewer devices may be alternatively implemented or provided.

In particular, according to the embodiment of the present disclosure, the processes described above with reference to the flow diagrams may be implemented as a computer software program. For example, an embodiment of the present disclosure comprises a computer program product comprising a computer program carried on a non-transitory computer-readable medium, the computer program containing program codes for performing the methods illustrated by the flow diagrams. In such an embodiment, the computer program may be downloaded and installed from a network by the communication device 609, or installed from the storage device 608, or installed from the ROM 602. The computer program, when executed by the processing device 601, performs the above functions defined in the methods of the embodiments of the present disclosure.

It should be noted that the above computer-readable medium of the present disclosure may be a computer-readable signal medium or a computer-readable storage medium or any combination of the above two. The computer-readable storage medium may be, for example, but is not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program, wherein the program can be used by or in conjunction with an instruction execution system, apparatus, or device. However, in the present disclosure, the computer-readable signal medium may include a data signal propagated in baseband or as part of a carrier wave, in which computer-readable program codes are carried. Such a propagated data signal may take a variety of forms, including, but not limited to, an electromagnetic signal, optical signal, or any suitable combination of the forgoing. The computer-readable signal medium may also be any computer-readable medium other than the computer-readable storage medium, wherein the computer-readable signal medium can send, propagate, or transmit a program for use by or in conjunction with an instruction execution system, apparatus, or device. The program codes contained on the computer-readable medium may be transmitted using any appropriate medium, including but not limited to: a wire, an optical cable, RF (Radio Frequency), etc., or any suitable combination of the foregoing.

In some implementations, a client and a server may communicate using any currently known or future developed network protocol, such as HTTP (HyperText Transfer Protocol), and may be interconnected with any form or medium of digital data communication (e.g., a communication network). Examples of the communication network include a local area network (“LAN”), a wide area network (“WAN”), an internet (e.g., the Internet), and a peer-to-peer network (e.g., an ad hoc peer-to-peer network), as well as any currently known or future developed network.

The above computer-readable medium may be contained in the above electronic device; or may exist separately without being assembled into the electronic device.

The above computer-readable medium has carried thereon one or more programs which, when executed by the electronic device, cause the electronic device to: acquire first background feature points from a first to-be-completed frame of a to-be-completed video, and acquire second background feature points from a previous frame of the first to-be-completed frame, wherein the first background feature points are feature points extracted from a background of the first to-be-completed frame, and the second background feature points are feature points extracted from a background of the previous frame; transform a completion frame of the previous frame by using the first background feature points and the second background feature points to obtain a transformation frame, wherein the completion frame of the previous frame is a frame obtained by video completion; and performing the video completion on the first to-be-completed frame by using the transformation frame to obtain a target video.

Computer program codes for performing the operation of the present disclosure may be written in one or more programming languages or a combination thereof, wherein the above programming language includes but is not limited to an object-oriented programming language such as Java, Smalltalk, and C++, and also includes a conventional procedural programming language, such as a “C” language or a similar programming language. The program codes may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or a wide area network (WAN), or may be connected to an external computer (for example, through the Internet using an Internet service provider).

The flow diagrams and block diagrams in the drawings illustrate the possibly implemented architecture, functions, and operations of the system, method and computer program product according to various embodiments of the present disclosure. In this regard, each block in the flow diagrams or block diagrams may represent a module, program segment, or part of the codes, which includes one or more executable instructions for implementing a specified logical function. It should also be noted that, in some alternative implementations, functions noted in blocks may occur in a different order from those noted in the drawings. For example, two blocks shown in succession may, in fact, be executed substantially concurrently, or they may sometimes be executed in a reverse order, which depends upon the functions involved. It will also be noted that each block in the block diagrams and/or flow diagrams, and a combination of the blocks in the block diagrams and/or flow diagrams, can be implemented by a special-purpose hardware-based system that performs specified functions or operations, or by a combination of special-purpose hardware and computer instructions.

The involved modules described in the embodiments of the present disclosure may be implemented by software or hardware. The name of the module does not, in some cases, constitute a limitation on the module itself.

The functions described above herein may be executed, at least partially, by one or more hardware logic components. For example, without limitation, a hardware logic component of an exemplary type that may be used includes: a field programmable gate array (FPGA), an application specific integrated circuit (ASIC), an application specific standard parts (ASSP), a system on chip (SOC), a complex programmable logic device (CPLD), and the like.

In the context of this disclosure, a machine-readable medium may be a tangible medium, which can contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, example 1 provides a video completion method, comprising: acquiring first background feature points from a first to-be-completed frame of a to-be-completed video, and acquiring second background feature points from a previous frame of the first to-be-completed frame, wherein the first background feature points are feature points extracted from a background of the first to-be-completed frame, and the second background feature points are feature points extracted from a background of the previous frame; transforming a completion frame of the previous frame by using the first background feature points and the second background feature points to obtain a transformation frame, wherein the completion frame of the previous frame is a frame obtained by video completion; and performing the video completion on the first to-be-completed frame by using the transformation frame to obtain a target video.

According to one or more embodiments of the present disclosure, example 2 provides the method of example 1, wherein the acquiring first background feature points from a first to-be-completed frame of a to-be-completed video and acquiring second background feature points from a previous frame of the first to-be-completed frame comprises: segmenting a foreground area and a background area of the first to-be-completed frame and the previous frame respectively to obtain a first background and a second background respectively; and extracting the first background feature points from the first background and extracting the second background feature points from the second background.

According to one or more embodiments of the present disclosure, example 3 provides the method of example 1, wherein the transforming a completion frame of the previous frame by using the first background feature points and the second background feature points to obtain a transformation frame comprises: determining whether an inertial measurement unit of a camera device for capturing the to-be-completed video is available when the to-be-completed video is captured; and transforming the completion frame of the previous frame, on the basis of a determination result, the first background feature points, and the second background feature points, to obtain the transformation frame.

According to one or more embodiments of the present disclosure, example 4 provides the method of example 3, wherein transforming the completion frame of the previous frame, on the basis of a determination result, the first background feature points, and the second background feature points, to obtain the transformation frame comprises: if the determination result indicates that the inertial measurement unit is available when the to-be-completed video is captured, determining a translation transformation matrix of the first to-be-completed frame relative to the previous frame by using the first background feature points and the second background feature points; determining a rotation transformation matrix of the first to-be-completed frame relative to the previous frame by using the inertial measurement unit; and transforming the completion frame of the previous frame by using the translation transformation matrix and the rotation transformation matrix to obtain the transformation frame.

According to one or more embodiments of the present disclosure, example 5 provides the method of example 3, wherein transforming the completion frame of the previous frame, on the basis of a determination result, the first background feature points, and the second background feature points, to obtain the transformation frame comprises: if the inertial measurement unit is unavailable when the to-be-completed video is captured, dividing the first to-be-completed frame into a plurality of first grids and dividing the previous frame into a plurality of second grids, wherein the first grids and the second grids are in correspondence; performing noise filtering on the first background feature points within the first grids and performing the noise filtering on the second background feature points within the second grids; determining local transformation matrices of the first grids after the noise filtering relative to the second grids after the noise filtering, wherein the local transformation matrix is a homography matrix; and transforming the completion frame of the previous frame by using the local transformation matrices to obtain the transformation frame.

According to one or more embodiments of the present disclosure, example 6 provides the method of example 5, wherein the performing noise filtering on the first background feature points within the first grids and performing the noise filtering on the second background feature points within the second grids comprises: performing the noise filtering on the first background feature points within the first grids and performing the noise filtering on the second background feature points within the second grids by performing median filtering with a preset radius.

According to one or more embodiments of the present disclosure, example 7 provides the method of example 5, wherein the transforming the completion frame of the previous frame by using the local transformation matrices to obtain the transformation frame comprises: transforming the completion frame of the previous frame by using the local transformation matrices to obtain a to-be-compensated frame; and compensating the to-be-compensated frame by using an optical flow to obtain the transformation frame.

According to one or more embodiments of the present disclosure, example 8 provides the method of any of examples 1 to 7, wherein the performing the video completion on the first to-be-completed frame by using the transformation frame comprises: performing the video completion on the first to-be-completed frame by replacing a foreground area of the first to-be-completed frame with an area in the transformation frame that corresponds to the foreground area of the first to-be-completed frame.

According to one or more embodiments of the present disclosure, example 9 provides the method of any of examples 1 to 7, wherein the method further comprises: performing the video completion on the first to-be-completed frame by using a deep completion network if the first to-be-completed frame is a first frame of the to-be-completed video.

The foregoing description is only illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims. With regard to the apparatus in the above embodiment, the specific manner in which each module performs the operation has already been described in detail in the embodiment related to the method, and will not be elaborated herein.

1. A video completion method, comprising:
acquiring first background feature points from a first to-be-completed frame of a to-be-completed video and acquiring second background feature points from a previous frame of the first to-be-completed frame, wherein the first background feature points are feature points extracted from a background of the first to-be-completed frame, and the second background feature points are feature points extracted from a background of the previous frame;
transforming a completion frame of the previous frame by using the first background feature points and the second background feature points to obtain a transformation frame, wherein the completion frame of the previous frame is a frame obtained by video completion; and
performing the video completion on the first to-be-completed frame by using the transformation frame to obtain a target video.

2. The method according to claim 1, wherein the acquiring first background feature points from a first to-be-completed frame of a to-be-completed video and acquiring second background feature points from a previous frame of the first to-be-completed frame comprises:
segmenting a foreground area and a background area of the first to-be-completed frame and the previous frame respectively to obtain a first background and a second background respectively; and
extracting the first background feature points from the first background and extracting the second background feature points from the second background.

3. The method according to claim 1, wherein the transforming a completion frame of the previous frame by using the first background feature points and the second background feature points to obtain a transformation frame comprises:
determining whether an inertial measurement unit of a camera device for capturing the to-be-completed video is available when the to-be-completed video is captured; and
transforming the completion frame of the previous frame, on the basis of a determination result, the first background feature points, and the second background feature points, to obtain the transformation frame.

4. The method according to claim 3, wherein the transforming the completion frame of the previous frame, on the basis of a determination result, the first background feature points, and the second background feature points, to obtain the transformation frame comprises: if the determination result indicates that the inertial measurement unit is available when the to-be-completed video is captured,
determining a translation transformation matrix of the first to-be-completed frame relative to the previous frame by using the first background feature points and the second background feature points;
determining a rotation transformation matrix of the first to-be-completed frame relative to the previous frame by using the inertial measurement unit; and
transforming the completion frame of the previous frame by using the translation transformation matrix and the rotation transformation matrix to obtain the transformation frame.

5. The method according to claim 3, wherein the transforming the completion frame of the previous frame, on the basis of a determination result, the first background feature points, and the second background feature points, to obtain the transformation frame comprises: if the inertial measurement unit is unavailable when the to-be-completed video is captured,
dividing the first to-be-completed frame into a plurality of first grids and dividing the previous frame into a plurality of second grids, wherein the first grids and the second grids are in correspondence;
performing noise filtering on the first background feature points within the first grids and performing the noise filtering on the second background feature points within the second grids;
determining local transformation matrices of the first grids after the noise filtering relative to the second grids after the noise filtering, wherein the local transformation matrix is a homography matrix; and
transforming the completion frame of the previous frame by using the local transformation matrices to obtain the transformation frame.

6. The method according to claim 5, wherein the performing noise filtering on the first background feature points within the first grids and performing the noise filtering on the second background feature points within the second grids comprises:
performing the noise filtering on the first background feature points within the first grids and performing the noise filtering on the second background feature points within the second grids by performing median filtering with a preset radius.

7. The method according to claim 5, wherein the transforming the completion frame of the previous frame by using the local transformation matrices to obtain the transformation frame comprises:
transforming the completion frame of the previous frame by using the local transformation matrices to obtain a to-be-compensated frame; and
compensating the to-be-compensated frame by using an optical flow to obtain the transformation frame.

8. The method according to claim 1, wherein the performing the video completion on the first to-be-completed frame by using the transformation frame comprises:
performing the video completion on the first to-be-completed frame by replacing a foreground area of the first to-be-completed frame with an area in the transformation frame that corresponds to the foreground area of the first to-be-completed frame.

9. The method according to claim 1, wherein the method further comprises:
performing the video completion on the first to-be-completed frame by using a deep completion network if the first to-be-completed frame is a first frame of the to-be-completed video.

10. (canceled)

11. A non-transitory computer-readable storage medium having thereon stored a computer program which, when executed by a processing device, implements the following video completion operations:
acquiring first background feature points from a first to-be-completed frame of a to-be-completed video and acquiring second background feature points from a previous frame of the first to-be-completed frame, wherein the first background feature points are feature points extracted from a background of the first to-be-completed frame, and the second background feature points are feature points extracted from a background of the previous frame;
transforming a completion frame of the previous frame by using the first background feature points and the second background feature points to obtain a transformation frame, wherein the completion frame of the previous frame is a frame obtained by video completion; and
performing the video completion on the first to-be-completed frame by using the transformation frame to obtain a target video.

12. An electronic device, comprising:
a storage device having a computer program stored thereon; and
a processing device configured to execute the computer program in the storage device to implement the following video completion operations:
acquiring first background feature points from a first to-be-completed frame of a to-be-completed video and acquiring second background feature points from a previous frame of the first to-be-completed frame, wherein the first background feature points are feature points extracted from a background of the first to-be-completed frame, and the second background feature points are feature points extracted from a background of the previous frame;
transforming a completion frame of the previous frame by using the first background feature points and the second background feature points to obtain a transformation frame, wherein the completion frame of the previous frame is a frame obtained by video completion; and
performing the video completion on the first to-be-completed frame by using the transformation frame to obtain a target video.

13. (canceled)

14. (canceled)

15. The storage medium according to claim 11, wherein the acquiring first background feature points from a first to-be-completed frame of a to-be-completed video and acquiring second background feature points from a previous frame of the first to-be-completed frame comprises:
segmenting a foreground area and a background area of the first to-be-completed frame and the previous frame respectively to obtain a first background and a second background respectively; and
extracting the first background feature points from the first background and extracting the second background feature points from the second background.

16. The storage medium according to claim 11, wherein the transforming a completion frame of the previous frame by using the first background feature points and the second background feature points to obtain a transformation frame comprises:
determining whether an inertial measurement unit of a camera device for capturing the to-be-completed video is available when the to-be-completed video is captured; and
transforming the completion frame of the previous frame, on the basis of a determination result, the first background feature points, and the second background feature points, to obtain the transformation frame.

17. The storage medium according to claim 16, wherein the transforming the completion frame of the previous frame, on the basis of a determination result, the first background feature points, and the second background feature points, to obtain the transformation frame comprises: if the determination result indicates that the inertial measurement unit is available when the to-be-completed video is captured, determining a translation transformation matrix of the first to-be-completed frame relative to the previous frame by using the first background feature points and the second background feature points;
determining a rotation transformation matrix of the first to-be-completed frame relative to the previous frame by using the inertial measurement unit; and
transforming the completion frame of the previous frame by using the translation transformation matrix and the rotation transformation matrix to obtain the transformation frame.

18. The storage medium according to claim 16, wherein the transforming the completion frame of the previous frame, on the basis of a determination result, the first background feature points, and the second background feature points, to obtain the transformation frame comprises: if the inertial measurement unit is unavailable when the to-be-completed video is captured, dividing the first to-be-completed frame into a plurality of first grids and dividing the previous frame into a plurality of second grids, wherein the first grids and the second grids are in correspondence;
performing noise filtering on the first background feature points within the first grids and performing the noise filtering on the second background feature points within the second grids;
determining local transformation matrices of the first grids after the noise filtering relative to the second grids after the noise filtering, wherein the local transformation matrix is a homography matrix; and
transforming the completion frame of the previous frame by using the local transformation matrices to obtain the transformation frame.

19. The storage medium according to claim 18, wherein the performing noise filtering on the first background feature points within the first grids and performing the noise filtering on the second background feature points within the second grids comprises:
performing the noise filtering on the first background feature points within the first grids and performing the noise filtering on the second background feature points within the second grids by performing median filtering with a preset radius.

20. The electronic device according to claim 12, wherein the acquiring first background feature points from a first to-be-completed frame of a to-be-completed video and acquiring second background feature points from a previous frame of the first to-be-completed frame comprises:
segmenting a foreground area and a background area of the first to-be-completed frame and the previous frame respectively to obtain a first background and a second background respectively; and
extracting the first background feature points from the first background and extracting the second background feature points from the second background.

21. The electronic device according to claim 12, wherein the transforming a completion frame of the previous frame by using the first background feature points and the second background feature points to obtain a transformation frame comprises:
determining whether an inertial measurement unit of a camera device for capturing the to-be-completed video is available when the to-be-completed video is captured; and
transforming the completion frame of the previous frame, on the basis of a determination result, the first background feature points, and the second background feature points, to obtain the transformation frame.

22. The electronic device according to claim 21, wherein the transforming the completion frame of the previous frame, on the basis of a determination result, the first background feature points, and the second background feature points, to obtain the transformation frame comprises: if the determination result indicates that the inertial measurement unit is available when the to-be-completed video is captured,
determining a translation transformation matrix of the first to-be-completed frame relative to the previous frame by using the first background feature points and the second background feature points;
determining a rotation transformation matrix of the first to-be-completed frame relative to the previous frame by using the inertial measurement unit; and
transforming the completion frame of the previous frame by using the translation transformation matrix and the rotation transformation matrix to obtain the transformation frame.

23. The electronic device according to claim 21, wherein the transforming the completion frame of the previous frame, on the basis of a determination result, the first background feature points, and the second background feature points, to obtain the transformation frame comprises: if the inertial measurement unit is unavailable when the to-be-completed video is captured,
dividing the first to-be-completed frame into a plurality of first grids and dividing the previous frame into a plurality of second grids, wherein the first grids and the second grids are in correspondence;
performing noise filtering on the first background feature points within the first grids and performing the noise filtering on the second background feature points within the second grids;
determining local transformation matrices of the first grids after the noise filtering relative to the second grids after the noise filtering, wherein the local transformation matrix is a homography matrix; and
transforming the completion frame of the previous frame by using the local transformation matrices to obtain the transformation frame.
